(19) United States
(12) Patent Application Publication
(10) Pub. No.: US 2004/0075242 A1
(43) Pub. Date: Apr. 22, 2004

(54) Extended tongue for trailer

(76) Inventor: Perry J. Richards, Angleton, TX (US)

Correspondence Address: Richard C. Litman, LITMAN LAW OFFICES, LTD., P.O. Box 15035, Arlington, VA, 22215, US

(21) Appl. No.: 10/677,603

(22) Filed: Oct. 3, 2003

Related U.S. Application Data
(60) Provisional application No. 60/415,755, filed on Oct. 4, 2002.

(51) Int. Cl. B60D 1/40; B60D 1/155

(52) U.S. Cl. 280/478.1; 280/491.2; 280/414.1

(57) ABSTRACT

A boat trailer having an extendable and retractable tongue. While leaving the trailer connected to the vehicle, a towing pin is pulled and a safety latch is unlocked and the tongue extension is extended until the safety latch pin catches holes for the extended position and the towing pin is reinstalled in already aligned holes. To retract the extension while leaving the trailer connected to the vehicle, the towing pin is pulled out and the safety latch is unlocked and the tongue extension is retracted until the safety latch pin catches holes for the retracted position and the towing pin is reinstalled in already aligned holes.

### CROSS-REFERENCE TO RELATED APPLICATION

This application claims the benefit of U.S. Provisional Patent Application Serial No. 60/415,755, filed Oct. 4, 2002.

### BACKGROUND OF THE INVENTION

1. Field of the Invention

The present invention relates to a boat trailer hitch tongue, which is able to extend when there is a need to launch the boat at a body of water, and then retract to a normal length, when being towed by a towing vehicle to and from the body of water. More particularly, the tongue is extended and retracted by use of a smaller extended frame member, which is inside another larger frame member, and includes a towing pin and a safety latch for securing the tongue in the extended or retracted position.

2. Description of Related Art

Trailer hitches commonly use a ball socket on the trailer tongue which mates with a ball on the receiver bar attached to the towing vehicle in order to connect the trailer to the towing vehicle. The trailer tongue on the trailer provides only enough distance between the towing vehicle and a boat loaded on the trailer to keep the boat and the rear of the towing vehicle from hitting each other in a turn. This distance between the boat and the rear of the vehicle is kept short enough to provide certain drivability and legal requirements, while towing the boat-loaded trailer behind the towing vehicle.

One of the problems frequently encountered is that this distance is so short that when the trailer and boat are to be launched down a ramp leading into the body of water, the towing vehicle's exhaust, rear wheels and rear brakes often get wet in the body of water. Consequently, the towing vehicle may have trouble driving back up the ramp or the towing vehicle may stall out on the ramp, if its exhaust is covered or the boat will not be far enough down the ramp to be in enough water to be easily and quickly launched.

A variety of devices or modifications to a trailer have been proposed to make easier the launching a boat off the trailer, while going down a ramp into a body of water. Some devices use a telescoping tongue with a smaller frame member inside a larger frame member. Exemplary telescoping tongues of this type are shown in U.S. Pat. No. 4,623,161, issued on Nov. 18, 1986 to Sprague; U.S. Pat. No. 5,114,168 issued on May 19, 1992 to Kehl; U.S. Pat. No. 3,599,256 issued on Aug. 17, 1971 to Carroll, Jr.; and U.S. Pat. No. 3,744,070 issued on Jul. 10, 1973 to Shaw.

A problem with these extendable tongues is that they use an inconvenient winch method to retract or extend the tongue or they have no automatic hole alignment method or they require a groove for hole alignment. Also, safety and security are compromised when a single safety latch or towing pin is used to lock and hold the position of the tongue extended or retracted.

The instant invention has an extendable and retractable trailer tongue that is extended and retracted while still connected to the towing vehicle on level ground. Also, a latch pin assists in an automatic positioning of the extendable member so that both a towing pin and a latch pin mate with their respective holes corresponding to the extended or retracted position. The spring loaded latch pin allows the extendable trailer tongue to be used with one person. Safety and security are greater, when both a towing and safety latch are used to lock hold the position of the tongue in either the extended or retracted positions.

Other devices include frame members, which extend and retract, boat guides on the trailer, cradles for the boat mounted on the trailer and tongue extensions that swing in and out in a retracted and extended position. Devices of this type are shown in U.S. Pat. No. 3,629,884, issued on Dec. 28, 1971 to Brown; U.S. Pat. No. 3,879,781, issued on Apr. 29, 1975 to Roschynailski; U.S. Pat. No. 4,114,772, issued on Sep. 19, 1978 to Beelow; U.S. Pat. No. 4,011,958, issued on Mar. 15, 1977 to Carrick; U.S. Pat. No. 4,507,016, issued on Mar. 26, 1985 to Honour, VII; U.S. Pat. No. 4,664,401, issued on May 12, 1987 to Carrick; U.S. Pat. No. 4,684,145, issued on Aug. 4, 1987 to Tingley; U.S. Pat. No. 5,004,260, issued on Apr. 2, 1991 to Smyly, Sr.; U.S. Pat. No. 5,013,206, issued on May 7, 1991 to Ernst et al.; U.S. Pat. No. 5,183,282, issued on Feb. 2, 1993 to Smyly Sr.; U.S. Pat. No. 5,380,143, issued on Jan. 10, 1995 to Mohan; U.S. Pat. No. 5,961,139, issued on Oct. 16, 1999 to Nichols, II; U.S. Pat. No. 6,302,425, issued on Oct. 16, 2001 to Springer; and Foreign Patent No. WO 93/02879, issued on Feb. 18, 1993.

None of the above inventions and patents use a simple, quick and easy device to control and use trailer tongue extension and retraction.

None of the above inventions and patents, taken either singly or in combination, is seen to describe the instant invention as claimed.

### SUMMARY OF THE INVENTION

The present invention is a boat trailer having an extendable and retractable tongue. The trailer tongue extension and retraction are done only at a launch area on level ground. The trailer tongue extension or retraction does not require the user to disconnect the trailer from the back of the towing vehicle. While leaving the trailer connected to the vehicle, a towing pin is pulled and a safety latch is unlocked and the tongue extension is pulled out until the safety latch pin catches holes for the extended position and the towing pin is reinstalled in already aligned holes. To retract the extended tongue, while leaving the trailer connected to the vehicle, the towing pin is pulled out and the safety latch is unlocked and the tongue extension is pushed in until the safety latch pin catches holes for the retracted position and the towing pin is reinstalled in already aligned holes. The pushing and pulling of the tongue extension with the weight of the boat still on the trailer can be done by the towing vehicle. The safety latch allows for the holes of both the towing pin and the latch pin to line up for both the extended and retracted positions.

Accordingly, it is a principal object of the invention to provide an extendable and retractable trailer tongue, which allows for quick and easy launching of a boat loaded on the trailer into the water.

It is another object of the invention to provide an extendable and retractable trailer tongue, where the boat trailer and towing vehicle do not have to be uncoupled during the extension and retraction process.

It is a further object of the invention to provide an extendable and retractable trailer tongue, which allows for quick and easy launching of a boat loaded on the trailer into the water without getting the wheels, brakes and exhaust of the towing vehicle wet.

Still another object of the invention is to provide an extendable and retractable trailer tongue, which allows for quick and easy alignment of two pins (towing pin and latch pin) and holes to hold the extendable tongue in either extended or retracted position.

Still another object of the invention is to provide an extendable and retractable trailer tongue, which makes the trailer tongue stronger while in the towing or retracted position.

Still another object of the invention is to provide an extendable and retractable trailer tongue, which can be manufactured on new or fabricated on old boat trailers.

These and other objects of the present invention will become readily apparent upon further review of the following specification and drawings.

### BRIEF DESCRIPTION OF THE DRAWINGS

FIG. 1 is an environmental three-dimensional perspective view of the extendable trailer tongue in the towing or retracted position.

FIG. 2 is another three-dimensional perspective view of the extendable trailer tongue in the launching or extended position.

FIG. 3 is a detailed cut away view of the extendable tongue towing pin along section line 3 in FIG. 2.

FIG. 4 is a detailed cut away view of the extendable tongue latch along section line 4 in FIG. 2.

### DETAILED DESCRIPTION OF THE PREFERRED EMBODIMENT

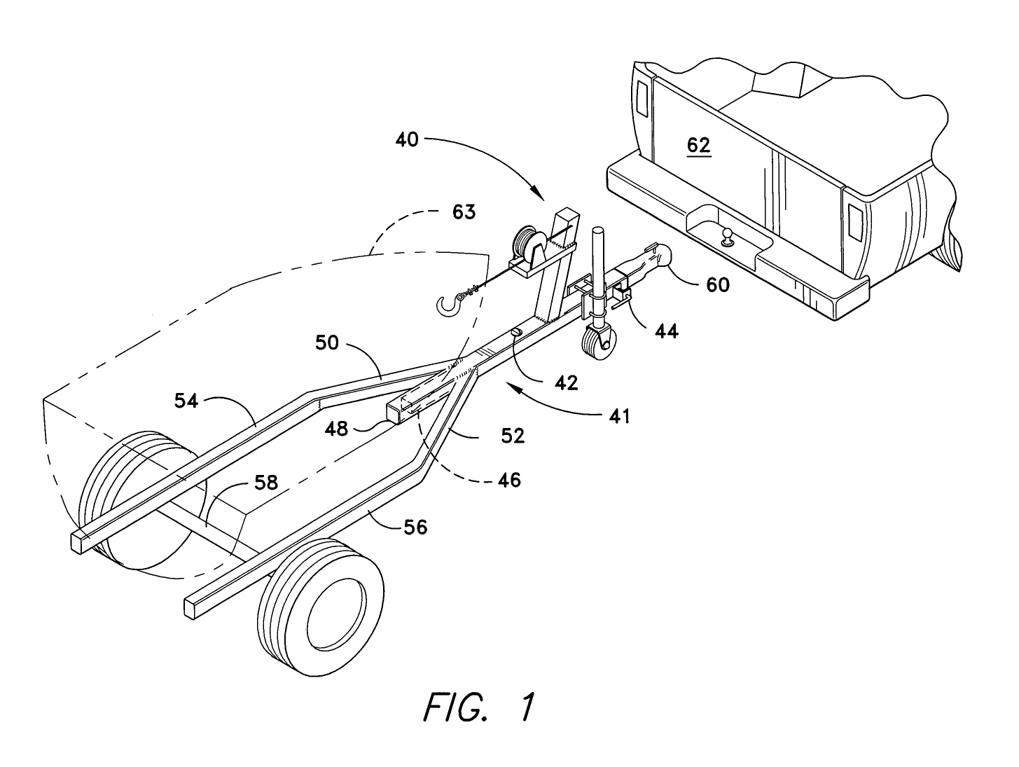

FIG. 1 shows a perspective side view of a boat trailer 40 having an extendable tongue 41 with a towing pin 42, safety latch 44, inner or extended frame member 46 and outer or short frame member 48. Outer frame member 48 is permanently attached (welded) to the rest of the frame members 50, 52, 54, 56 of the trailer 40 that also provide attachment to wheels and axle 58. The inner frame member 46 has a ball socket 60 attached to it, which is connected to the towing vehicle. Outer frame member 48 is shaped the same as inner frame member 46. The outer frame member 48 is sized larger to easily contain the smaller inner frame member 46 and allow it to slide inside of the outer frame 48. Therefore, any or all of the frame members 46, 48 and 50-56 can be rectangular or tubular and made of carbon steel, aluminum, etc. The distance between the boat 63 and the rear of the towing vehicle 62 in the towing or retracted mode should be dictated by legal limits and/or weight restrictions.

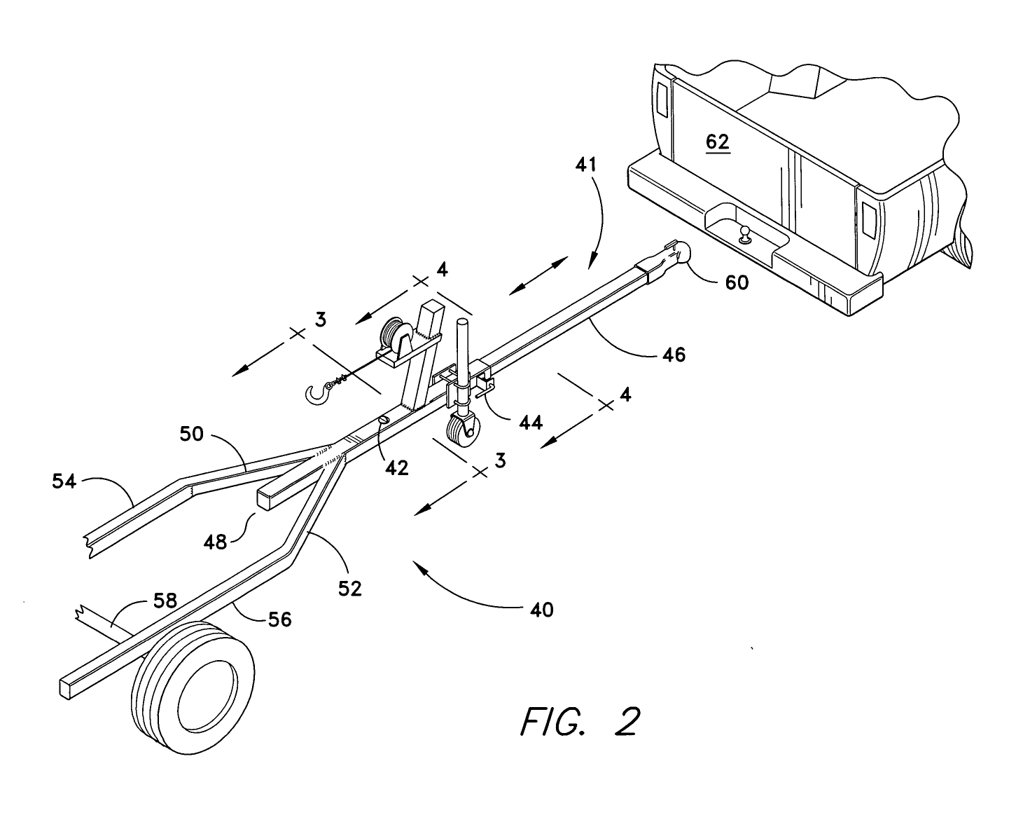

FIG. 2 shows a perspective side view of the boat trailer 40 having an extendable tongue 41 where all the elements in FIG. 1 are the same except that the smaller inner frame member 46 is pulled out or extended from within the outer frame member 48 to the point where the towing pin 42 and the safety latch 44 can engage into holes corresponding to the extended position. Thus, the portion of the inner frame member 46 remaining inside the outer frame member 48 is just sufficient for the towing pin 42 to align and engage into holes in both inner frame 46 and outer frame 48 members; for latch 44 to engage in its holes; and provide enough strength when launching the boat with its weight. The extra distance between the rear of the tow vehicle 62 and front of boat 63, that the extension may provide, is as long as 4 to 6 feet.

It is possible to modify an already built trailer into an extendable one of the present invention. For example, the outer frame member 48 can be an original section of a standard nonextendable trailer tongue cut off at a section close to the ball socket 60. Then, the cut off section having the ball socket 60 can be welded onto a new section of frame, like 46, having the same shape and smaller size that will slide inside the other larger section, like 48, connected to the axle. Holes would be added for the safety pin latch and the towing pin at appropriate positions for both retraction and extension. The towing pin 42 is added and the latch 44 is welded on at an appropriate position on the other section, like 48, connected to the axle.

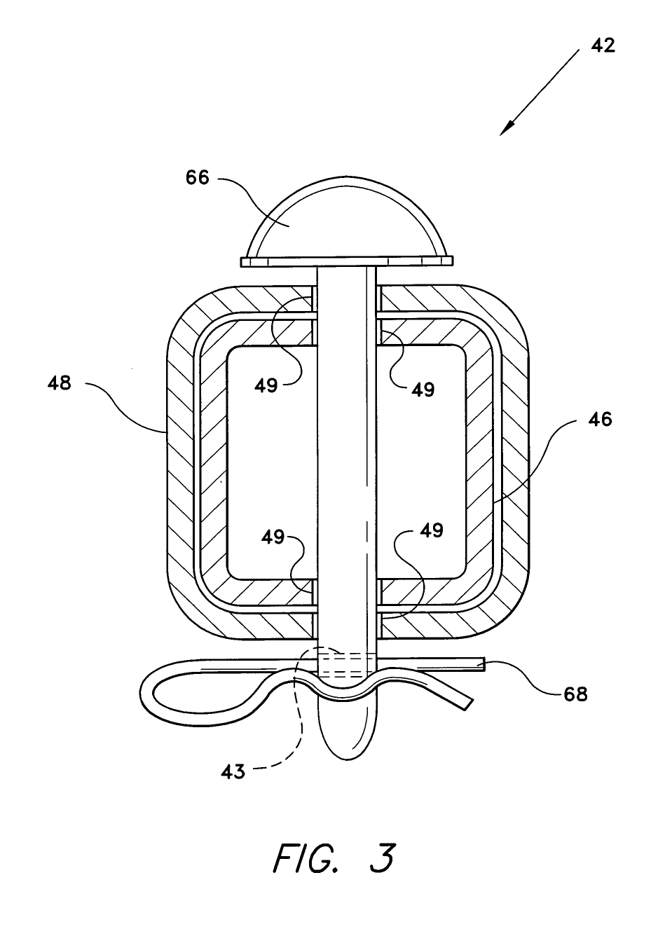

FIG. 3 is a detailed cut away view of the extendable tongue towing pin along section line 3 in FIG. 2, showing towing pin 42 inserted through holes 49 in both the top and bottom walls of the inner frame member 46 and outer frame member 48. The towing pin 42 is inserted through holes 49 in both the inner frame member 46 and outer frame member 48 to ensure the safe and secure towing in the retracted position and launching down a ramp to a body of water in the extended position. FIG. 3 shows that the towing pin 42 is long enough to engage into holes 49 positioned on the inner frame 46 and outer frame 48 members on opposite sides of both inner frame 46 and outer frame 48 members. Therefore, in both the retracted and extended positions the towing pin 42 extends through both inner frame 46 and outer frame 48 members completely from top to bottom. A knob 66 on the top of the towing pin 42 keeps the pin 42 from going through the mated holes and falling completely out the other end. The knob 66 may have the shape of a handle. A cotter key 68 goes through a hole 43 in (or snaps on) the bottom of the towing pin 42 to prevent the towing pin 42 from popping out of the mated holes 49. The towing pin 42 can be about ⅞ of an inch diameter. The corresponding extended and retracted holes 49 of both the inner frame 46 and outer frames 48 on top and bottom walls of the inner frame 46 and outer frame 48 will be slightly larger than the diameter of towing pin 42. The towing pin 42 holes 49 of the inner frame 46 and outer frame 48 members can be located on the side walls or at positions along the outer frame member 48, as long as the locations serve to secure the inner frame 46 and outer frame 48 members through all the walls of the frame members and do not cause overloading of the trailer on either of the frame members.

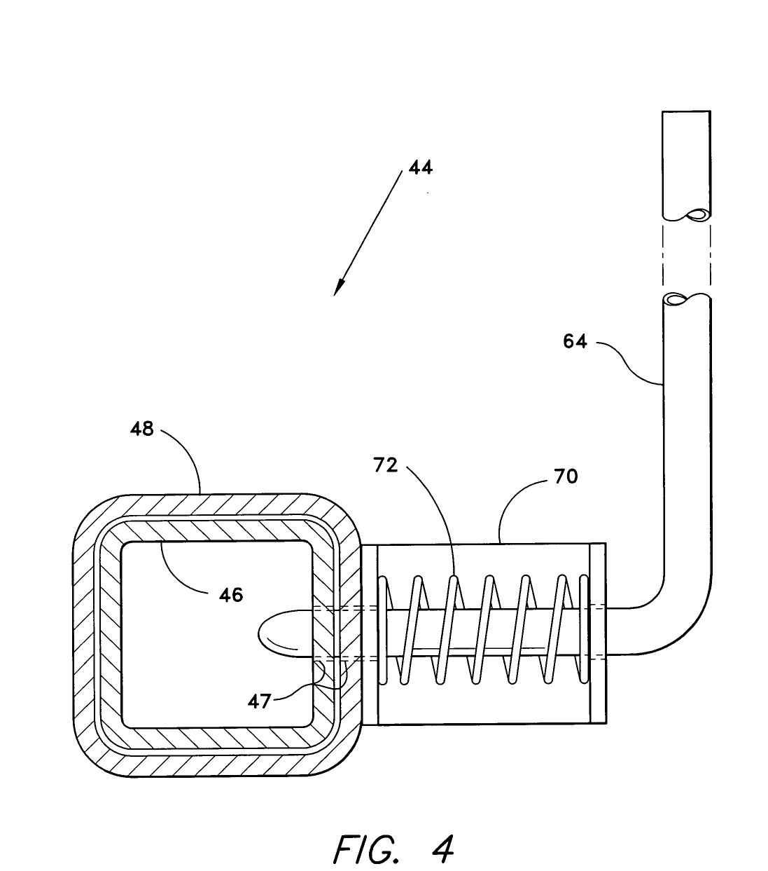

FIG. 4 is a detailed cut away view of the extendable tongue latch 44 along section line 4 in FIG. 2, mounted on the right-hand side wall of the outer frame member 48. The latch pin 64 of the latch engages into the mated holes of the inner frame 46 and outer frame 48 on only one side wall of both the inner frame 46 and outer frame 48. A bracket member 70 is mounted (welded) to the side wall of the outer frame member 48.

The latch pin 64 is held in place by the bracket member 70. A not fully compressed spring 72 pushes against the bracket member 70 and the latch pin 64, using cotter keys or flanges, in order to push and hold latch pin 64 into both of the mated holes 47 on the side walls of the inner frame 46 and outer frame 48. When the pin 64 is pulled out of the mated holes 47 with maximum compression of the spring 72, the pin 64 stays aligned with the hole 47 in the outer frame 48.

In order to extend or retract the inner frame 46, the pin 64 of the latch 44 is pulled out enough to retract the pin 64 out of the mated hole of the side wall of the inner frame member 46. The inner frame 46 is extended or retracted a short distance so that the holes in the inner frame 46 and outer frame 48 do not align. Then, the pin 64 is released and the spring forces the pin 64 through the hole in the outer frame 48 and against the solid side wall of the inner frame 46. Then, the inner frame 46 is slid further in an extended or retracted direction, until the retracted or extended hole of the inner frame 46 aligns with the outer frame 48 hole, at which point the spring 72 will automatically force the pin 64 into the aligned hole at the new position (retracted or extracted).

Thus, the user does not have to know exactly where along the inner frame 46 the other latch pin 64 hole is located, while extending or retracting the inner frame member 46 part of the tongue. The spring force on the latch pin 64 will locate and align the extended or retracted hole of the inner frame 46 at the latch pin 64 and consequently the extended or retracted holes 49 of the towing pin 42. Again, the user does not have to know exactly where along the inner frame 46 and outer frame 48 the other towing pin 42 holes are located. The latch 44 can be mounted on top or bottom or side walls at most any position along the outer frame 48 member as long as the location is easily accessible.

In operation with regard to FIGS. 1 and 2, to extend the tongue for launching the boat, a towing pin 42 is pulled and a safety latch 44 is unlocked (pulled and released after a short pull of the tongue extension 46) and the tongue extension 46 is pulled out until the safety latch 44 catches holes for the extended position and the towing pin is reinstalled in already aligned holes. To retract the tongue for towing, the towing pin 42 is pulled out and the safety latch 44 is unlocked (pushed and released after a short push of the tongue extension 46) and the tongue extension 46 is pushed in until the safety latch 44 catches holes for the retracted position and the towing pin 42 is reinstalled in already aligned holes. The pushing and pulling of the tongue extension 46 with the weight of the boat 63 still on the trailer can be done by the towing vehicle 62. The safety latch 44 allows for the holes of both the towing pin 42 and the latch pin 44 to line up for both the extended and retracted positions.

It is to be understood that the present invention is not limited to the sole embodiments described above, but encompasses any and all embodiments within the scope of the following claims.

I claim:

1. An extendable boat trailer, comprising:
a rear frame assembly defining a boat receiving portion having a front end, a rear end and a plurality of wheels disposed along said rear end;
an extendable trailer tongue extending forwardly from said rear frame assembly having an outer tongue member secured to said rear frame assembly and an inner tongue member telescopingly and slidably engaged inside of said outer tongue member;
a plurality of pin receiving holes disposed along said trailer tongue, said pin receiving holes extending through said outer tongue member and said inner tongue member;
a plurality of latch receiving holes disposed along said trailer tongue, said latch receiving holes extending through said outer tongue member and said inner tongue members,
a towing pin that removably engages said pin receiving holes; and
a safety latch that removably engages said latch receiving holes;
whereby said expandable tongue alternates between an extended position and a retracted position by having said inner tongue member slide relative to said outer tongue member and said expandable tongue is locked in the extended position and the retracted position by said towing pin and said safety latch each engaging on of said pin receiving holes and one of said latch receiving holes.

2. The extendable boat trailer according to claim 1, wherein said extendable trailer tongue is welded to said rear frame assembly.

3. The extendable boat trailer according to claim 1, wherein said inner tongue member comprises an elongate, hollow member having a cross section, a trailer mounting end, a distal end, a top, a bottom, and a pair of sides.

4. The extendable boat trailer according to claim 3, wherein said outer tongue member comprises an elongate, hollow member having a cross section that is slightly larger than the cross section of said inner tongue member to allow inner tongue member to slide freely through said outer tongue member, a trailer mounting end, a distal end, a top, a bottom, and a pair of sides.

5. The extendable boat trailer according to claim 1, further comprising a ball socket disposed on the distal end of said inner tongue member adapted for securing said trailer to the tow vehicle.

6. The extendable boat trailer according to claim 4, wherein said inner tongue member cross section and said outer tongue member cross section are selected from the group consisting of generally rectangular and generally tubular cross sections.

7. The extendable boat trailer according to claim 1, wherein said plurality of pin receiving holes comprise a retraction set of holes and an expansion set of holes, said retraction holes and said expansion holes are disposed on the top of said inner tongue member and the top of said outer tongue member and extend through the bottom of said inner tongue member and the bottom of said outer tongue member, whereby said towing pin aligns and engages said retraction set of holes when the trailer is in the retracted position and align an engage the expansion set of holes when the trailer is in the expanded position.

8. The extendable boat trailer according to claim 1, wherein said towing pin comprises an elongate body having a shaft with a top, a bottom and a fastener receiving hole disposed through the bottom, and a knob disposed on the top of said shaft, whereby said shaft extends through said inner tongue member and said outer tongue member and said knob prevents said pin from falling through said pin receiving holes.

9. The extendable boat trailer according to claim 8, further comprising a cotter key extending through the fastener receiving hole in said towing pin to secure said towing pin in engagement with said inner tongue member and said outer tongue member.

10. The extendable boat trailer according to claim 4, wherein said safety latch is secured to one of the side walls of said outer tongue member.

11. The extendable boat trailer according to claim 10, wherein said latch receiving holes comprise at least a fixed hole disposed on one of the side walls of said outer tongue member, a retraction latch hole and an expansion latch hole disposed on one of the side walls of said outer tongue member.

12. The extendable boat trailer according to claim 1, wherein said latch comprises a latch bracket mounted one of the side walls of said outer frame member, a latch pin for engaging said latch receiving holes and held into place by said bracket and a latch spring for urging said latch pin into engagement with said latch receiving holes.

13. An extendable trailer tongue, comprising:
an outer tongue member securable to a boat trailer assembly;
an inner tongue member telescopingly and slidably engaged inside of said outer tongue member;
a plurality of pin receiving holes disposed along said trailer tongue, said pin receiving holes extending through said outer tongue member and said inner tongue member;
a plurality of latch receiving holes disposed along said trailer tongue, said latch receiving holes extending through said outer tongue member and said inner tongue members,
a towing pin that removably engages said pin receiving holes; and
a safety latch that removably engages said latch receiving holes;
whereby said extendable tongue alternates between an extended position and a retracted position by having said inner tongue member slide relative to said outer tongue member and said expandable tongue is locked in the extended position and the retracted position by said towing pin and said safety latch each engaging on of said pin receiving holes and one of said latch receiving holes.

14. The extendable trailer tongue according to claim 13, wherein said inner tongue member comprises an elongate, hollow member having a cross section, a trailer mounting end, a distal end, a top, a bottom, and a pair of sides.

15. The extendable trailer tongue according to claim 14, wherein said outer tongue member comprises an elongate, hollow member having a cross section that is slightly larger than the cross section of said inner tongue member to allow inner tongue member to slide freely through said outer tongue member, a trailer mounting end, a distal end, a top, a bottom, and a pair of sides.

16. The extendable trailer tongue according to claim 13, further comprising a ball socket disposed on the distal end of said inner tongue member adapted for securing said trailer tongue to a tow vehicle.

17. The extendable trailer tongue according to claim 13, wherein said plurality of pin receiving holes comprise a retraction set of holes and an expansion set of holes, said retraction holes and said expansion holes are disposed on the top of said inner tongue member and the top of said outer tongue member and extend through the bottom of said inner tongue member and the bottom of said outer tongue member, whereby said towing pin aligns and engages said retraction set of holes when the trailer tongue is in the retracted position and align an engage the expansion set of holes when the trailer tongue is in the expanded position.

18. The extendable trailer tongue according to claim 13, wherein said towing pin comprises an elongate body having a shaft with a top, a bottom and a fastener receiving hole disposed through the bottom, and a knob disposed on the top of said shaft, whereby said shaft extends through said inner tongue member and said outer tongue member and said knob prevents said pin from falling through said pin receiving holes.

19. The extendable trailer tongue according to claim 18, further comprising a cotter key extending through the fastener receiving hole in said towing pin to secure said towing pin in engagement with said inner tongue member and said outer tongue member.

20. The extendable trailer tongue according to claim 13, wherein said latch comprises a latch bracket mounted one of the side walls of said outer frame member, a latch pin for engaging said latch receiving holes and held into place by said bracket and a latch spring for urging said latch pin into engagement with said latch receiving holes.
